(19) United States
(12) Patent Application Publication
(10) Pub. No.: US 2025/0187371 A1
(43) Pub. Date: Jun. 12, 2025

(54) CLAMP DEVICE

(71) Applicant: KAL TIRE, Vernon (CA)

(72) Inventors: Clayton Wilford Russell MCMUNN, Lake Country (CA); Jan Peter NILSSON, Kelowna (CA)

(21) Appl. No.: 19/106,978

(22) PCT Filed: Aug. 26, 2022
(86) PCT No.: PCT/CA2022/051299

§ 371 Date: Feb. 26, 2025

(51) Int. Cl. B60B 29/00; B25B 5/04; B25B 5/06; B25B 5/14

(52) U.S. Cl. CPC B60B 29/00; B25B 5/04; B25B 5/06; B25B 5/14

(57) ABSTRACT

The present disclosure provides clamp devices that may be operated remotely to facilitate the installation, removal and other handling of wheels and tires for large vehicles. The clamp devices generally include an attachment mechanism, a gripping mechanism, an actuating link operable to move the gripping mechanism between an open and closed position, and an actuator to activate the actuating link.

### FIELD

This disclosure relates generally to clamp devices which may be operated remotely to facilitate the installation, removal and other handling of wheels and tires for large vehicles.

### RELATED ART

Large vehicles, such as wheel loaders, backhoes, tractors, graders, trenchers, semi-trucks and the like, are often equipped with wheels that have diameters larger than human height and with tire/wheel combinations that weigh several thousand pounds. Such wheels cannot be manually manipulated. Further, even with mechanical lifting assistance, it can be difficult and dangerous to maneuver very heavy wheels into proper alignment with hubs, lugs and other connections necessary for mounting and removal from a vehicle. These difficulties are often exacerbated by a lack of working room around the wheel and the need to work on a vehicle in the field rather than a shop.

For example, with current methods of removing off-the-road (OTR) wheels, it is necessary to utilize a tire manipulator to safely hold the wheel while a technician removes/installs the last two/first two lug nuts of the wheel. The manipulator prevents the wheel from potentially tipping over and injuring the technician. However, it is unsafe for the technician to remove/install the remaining/initial lug nuts while the tire manipulator is in the work area since the tire manipulator is a large piece of heavy machinery with the potential to injure the technician as well.

Accordingly, it would be desirable to have a device which could be operated remotely by the technician to assist in the process of removing and installing the OTR wheels from the vehicle in order to improve the overall safety of such process.

### SUMMARY

According to at least one embodiment, there is disclosed a clamp device for gripping a stud of a wheel mounting assembly for mounting a wheel, the clamp device comprising: a gripping mechanism movable between an open position to locate the gripping mechanism over the stud and a closed position to grip and hold the stud; an actuating link for moving the gripping mechanism between the open position and the closed position; an actuator assembly comprising: a frame defining a sliding axis; a slider for controlling the actuating link, the slider slidably engaging the frame and slidable along the sliding axis; and a first actuator and a second actuator supported by the frame, the first and second actuators moving the slider in response to operating commands inputted by a user; and an attachment mechanism operable to releasably attach the clamp device to the wheel.

In some embodiments, the actuating link is movable between an opening position and a closing position; the gripping mechanism is configured to move to the open position when the actuating link moves to the opening position; and the gripping mechanism is configured to move to the closed position when the actuating link moves to the closing position.

In some embodiments, the actuating link is configured to cause the gripping mechanism to move to the open position when the actuating link moves to the opening position.

In some embodiments, the actuating link is configured to cause the gripping mechanism to move to the closed position when the actuating link moves to the closing position.

In some embodiments, the first and second actuators are operable to slide the slider along the sliding axis between a first slider position and a second slider position in response to the operating commands; the actuating link is configured to move to the opening position when the slider slides to the first slider position; and the actuating link is configured to move to the closing position when the slider slides to the second slider position.

In some embodiments, the slider is configured to cause the actuating link to move to the opening position when the slider slides to the first slider position.

In some embodiments, the slider is configured to cause the actuating link to move to the closing position when the slider slides to the second slider position.

In some embodiments, the slider is configured to slide to the first slider position when the first and second actuators retract; and the slider is configured to slide to the second slider position when the first and second actuators extend.

In some embodiments, the first and second actuators are configured to actuate substantially synchronously.

In some embodiments, the slider is configured to slide along the sliding axis when the first and second actuators actuate asynchronously.

In some embodiments, the slider engages the actuating link at a plurality of contact points.

In some embodiments, the slider engages the actuating link at two contact points.

In some embodiments, the slider slidably engages an external surface of the frame; and the frame defines a central cavity configured to accommodate at least a portion of the stud when the gripping mechanism grips the stud.

In some embodiments, the attachment mechanism comprises a support structure engaging the frame, the support structure defining a central opening; and at least a part of the frame is positioned through the central opening such that the central cavity is aligned with the central opening.

In some embodiments, the slider comprises a slider arm, the slider arm engaging the actuating link; the support structure defines a slider opening configured to accommodate at least a portion of the slider arm; and the slider arm is configured to move through the slider opening when the slider slides along the sliding axis.

In some embodiments, the frame comprises an alignment slot; the slider comprises an alignment post engaging the alignment slot; and engagement of the alignment post with the alignment slot prevents rotation of the slider relative to the frame.

In some embodiments, engagement of the alignment post with the alignment slot restricts a sliding range of the slider.

In some embodiments, the frame supports the gripping mechanism.

In some embodiments, the slider comprises a proximal side and a distal side opposite the proximal side, the proximal side engaging the actuating link; and each of the first and second actuators comprises a proximal end and a distal end opposite the proximal end, the proximal end engaging the distal side of the slider, and the distal end supported by the frame.

In some embodiments, the first and second actuators are electromagnetic actuators.

In some embodiments, the clamp device further comprises a receiver receiving the operating commands inputted by the user and controlling the first and second actuators to move the slider in response to the operating commands.

According to at least one embodiment, there is disclosed a clamp device for gripping a stud of a wheel mounting assembly for mounting a wheel, the clamp device comprising: a gripping mechanism movable between an open position to locate the gripping mechanism over the stud and a closed position to grip and hold the stud; an actuating link for moving the gripping mechanism between the open position and the closed position; an actuator for controlling the actuating link in response to operating commands inputted by a user; and an attachment mechanism operable to releasably attach the clamp device to an attachment surface of the wheel, the attachment surface substantially perpendicular to an axis of rotation of the wheel.

In some embodiments, the attachment mechanism comprises a first anchoring device and a second anchoring device, each of the first and second anchoring devices operable to releasably attach to the attachment surface.

In some embodiments, the attachment mechanism further comprises a support structure supporting the first and second anchoring devices.

In some embodiments, the support structure positions the first and second anchoring devices on opposing sides of the gripping mechanism.

In some embodiments, the attachment surface is on a center disc of the wheel, the center disc comprising a plurality of openings regularly spaced along a circumferential axis of the center disc, the openings configured to receive a plurality of studs of the wheel mounting assembly; and the support structure positions the first and second anchoring devices to attach to the attachment surface between the holes along the circumferential axis when the gripping mechanism grips the stud.

In some embodiments, the first and second anchoring devices are movable along the support structure.

In some embodiments, the first and second anchoring devices comprise switchable magnetic devices.

According to at least one embodiment, there is disclosed a clamp device for gripping a stud of a wheel mounting assembly for mounting a wheel, the clamp device comprising a gripping assembly comprising: a gripping mechanism movable between an open position to locate the gripping mechanism over the stud and a closed position to grip and hold the stud; an actuating link for moving the gripping mechanism between the open position and the closed position; and an actuator for controlling the actuating link in response to operating commands inputted by a user; an attachment mechanism operable to releasably attach the clamp device to the wheel; and a flexible linkage disposed between the gripping assembly and the attachment mechanism, the flexible linkage configured to accommodate movement between the gripping assembly and the attachment mechanism.

In some embodiments, the flexible linkage is configured to accommodate movement between the gripping assembly and the attachment mechanism such that the gripping mechanism is operable to self-align onto the stud as it moves to the closed position.

In some embodiments, the flexible linkage joins the gripping assembly to the attachment mechanism.

In some embodiments, the flexible linkage comprises at least one O-ring.

In some embodiments, the flexible linkage comprises at least one foam ring.

In some embodiments, the flexible linkage comprises: a plurality of foam rings arranged in a stack, the stack having a first end and a second end opposite the first end; a first O-ring disposed at the first end; and a second O-ring disposed at the second end.

According to at least one embodiment, there is disclosed a clamp device for gripping a stud of a wheel mounting assembly for mounting a wheel, the clamp device comprising: a gripping mechanism movable between an open position to locate the gripping mechanism over the stud and a closed position to grip and hold the stud; an actuating link for moving the gripping mechanism between the open position and the closed position; an actuator for controlling the actuating in response to operating commands inputted by a user; an attachment mechanism operable to releasably attach the clamp device to the wheel; and an outer housing surrounding at least one of the gripping mechanism, the actuating link, and the actuator, the outer housing comprising a grasping point graspable by the user to position the clamp device.

In some embodiments, wherein the outer housing comprises a rigid shell configured to protect at least one of the gripping mechanism, the actuating link, and the actuator from impacts.

In some embodiments, the actuating link is movable between an opening position and a closing position; the gripping mechanism is configured to move to the open position when the actuating link moves to the opening position; and the gripping mechanism is configured to move to the closed position when the actuating link moves to the closing position.

In some embodiments, the actuating link is configured to cause the gripping mechanism to move to the open position when the actuating link moves to the opening position.

In some embodiments, the actuating link is configured to cause the gripping mechanism to move to the closed position when the actuating link moves to the closing position.

In some embodiments, the actuator is an electromagnetic actuator.

In some embodiments, the clamp device further comprises a receiver receiving the operating commands inputted by the user and controlling the actuator to move the actuating link in response to the operating commands.

In some embodiments, the clamp device further comprises a transmitter for transmitting the operating commands to the receiver.

In some embodiments, the transmitter is a remote transmitter operable to remotely transmit the operating commands to the receiver.

In some embodiments, the transmitter transmits the operating commands over a wired connection.

In some embodiments, the transmitter transmits the operating commands over a wireless connection.

In some embodiments, the gripping mechanism is interchangeable with another gripping mechanism.

In some embodiments, the gripping mechanism comprises a pair of pivotally attached jaws.

In some embodiments, the actuating link comprises a collar configured to be movably disposed over the pair of pivotally attached jaws.

In some embodiments, at least one of the pair of pivotally attached jaws defines a slot; the collar comprises an inwardly projecting pin configured to slidably engage the slot; and engagement between the pin and the slot precisely guides movement of the at least one of the pair of pivotally attached jaws as the gripping mechanism moves between the open position and the closed position.

In some embodiments, the attachment mechanism comprises a switchable magnetic device.

In some embodiments, the clamp device further comprises an open indicator light configured to illuminate when the gripping mechanism is in the open position.

In some embodiments, the clamp device further comprises a closed indicator light configured to illuminate when the gripping mechanism is in the closed position.

According to at least one embodiment, there is disclosed a method of temporarily holding a wheel mounted onto a hub of a wheel mounting assembly, the hub having a plurality of studs onto which the wheel is mountable and the wheel having a plurality of stud holes configured to receive the plurality of studs, the method comprising attaching the clamp device of the present disclosure by the attachment mechanism to the wheel over and in line with a stud hole selected from the plurality of stud holes; inputting a first operating command to cause the actuating link to move the gripping mechanism to the closed position to hold the wheel mounted onto the hub; inputting a second operating command to cause the actuating link to move the gripping mechanism to the open position; and releasing the attachment mechanism from the wheel.

According to at least one embodiment, there is disclosed a method of temporarily holding a wheel mounted onto a hub of a wheel mounting assembly, the hub having a plurality of studs onto which the wheel is mounted, the method comprising: positioning the clamp device of the present disclosure over and in line with a stud selected from the plurality of studs; inputting a first operating command to cause the actuating link to move the gripping mechanism to the closed position to hold the wheel mounted onto the hub; attaching the clamp device by the attachment mechanism to the wheel; inputting a second operating command to cause the actuating link to move the gripping mechanism to the open position; and releasing the attachment mechanism from the wheel.

Other aspects and features will become apparent to those ordinarily skilled in the art upon review of the following description of illustrative embodiments in conjunction with the accompanying figures.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1 is a perspective view of a typical wheel mounting assembly.

FIG. 2 is a perspective view of a clamp device according to one embodiment attached to a typical wheel mounting assembly including a large diameter off-the-road (OTR) wheel.

FIG. 3 is a perspective view of a clamp device according to another embodiment.

FIG. 4 is an exploded view of the clamp device of FIG. 3.

FIG. 5 is a top view of the clamp device of FIG. 3.

FIG. 6 is a side view of the clamp device of FIG. 3.

FIG. 7 is a cross-sectional view of the clamp device of FIG. 3 in an open position, taken along a section line marked FIGS. 7, 8 in FIG. 6.

FIG. 8 is a cross-sectional view of the clamp device of FIG. 3 in a closed position, taken along a section line marked FIGS. 7, 8 in FIG. 6.

FIG. 9 is a close-in top view of a gripping mechanism and an actuating link of the clamp device of FIG. 3 in the open position.

FIG. 10 is FIG. 9 with the actuating link shown partly transparent to expose the gripping mechanism.

FIG. 11 is a close-in top view of the gripping mechanism and the actuating link of the clamp device of FIG. 3 in the closed position.

FIG. 12 is FIG. 11 with the actuating link shown partly transparent to expose the gripping mechanism.

FIG. 13 is a close-in perspective view of a portion of an attachment mechanism of the clamp device of FIG. 3.

FIG. 14 is a perspective view of the clamp device of FIG. 3 attached to a wheel of a wheel mounting assembly and gripping a stud of the wheel mounting assembly.

FIG. 15 is a perspective view from above of a clamp device according to another embodiment.

FIG. 16 is a perspective view from below of the clamp device of FIG. 15.

### DETAILED DESCRIPTION

Clamp devices for releasably gripping wheel studs are described herein. Such clamp devices may be configured to be remotely opened and closed, and may be used, for example, as temporary substitutes for lug nuts during installation and removal of wheels of large vehicles.

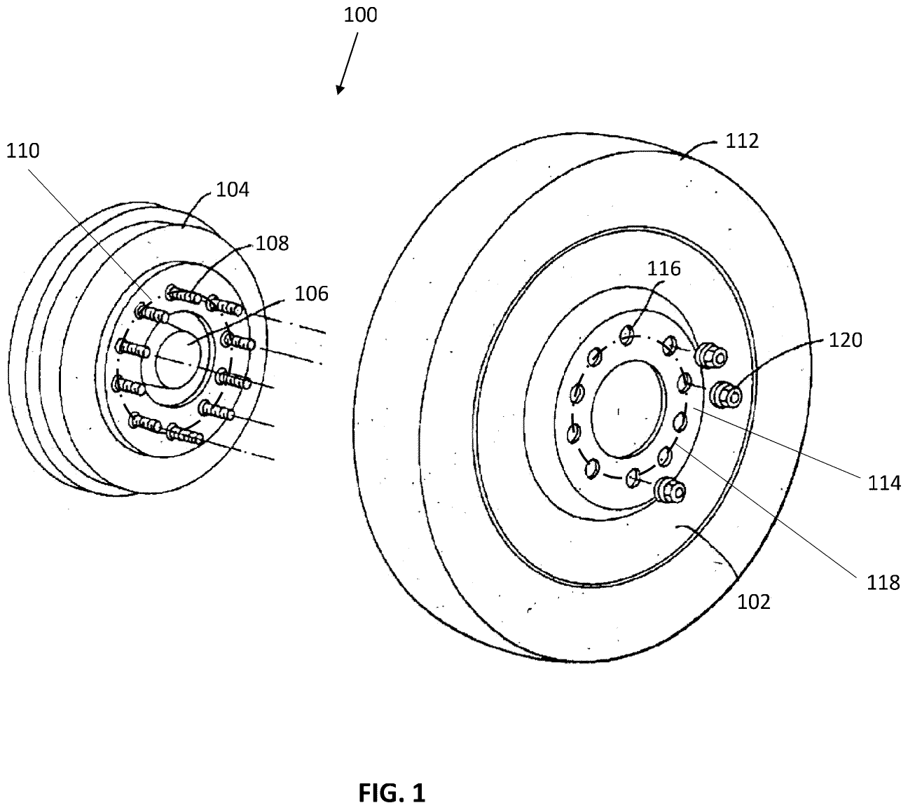

Referring to FIG. 1, a typical wheel mounting assembly is shown generally at 100 and includes a wheel 102 and a brake drum 104 mounted to a hub 106. The wheel mounting assembly 100 further includes a plurality of externally threaded bolts or studs, such as stud 108, which are mounted to the hub 106 along a circumferential axis 110. The wheel 102 includes a tire 112 and a center disc 114. The center disc 114 defines a plurality of stud holes, such as stud hole 116, which are arranged along a circumferential axis 118. The stud holes of the center disc 114 are aligned with the studs of the hub 106, such that the studs of the hub 106 will pass through the stud holes of the center disc 114 when the wheel 102 is mounted on the hub 106. For example, as depicted in FIG. 1, when the wheel 102 is mounted on the hub 106, the stud 108 will pass through the stud hole 116. Once the wheel 102 has been mounted on the hub 106, a plurality of internally threaded lug nuts, such as lug nut 120, may be provided to engage with the studs to secure the wheel 102 to the hub 106.

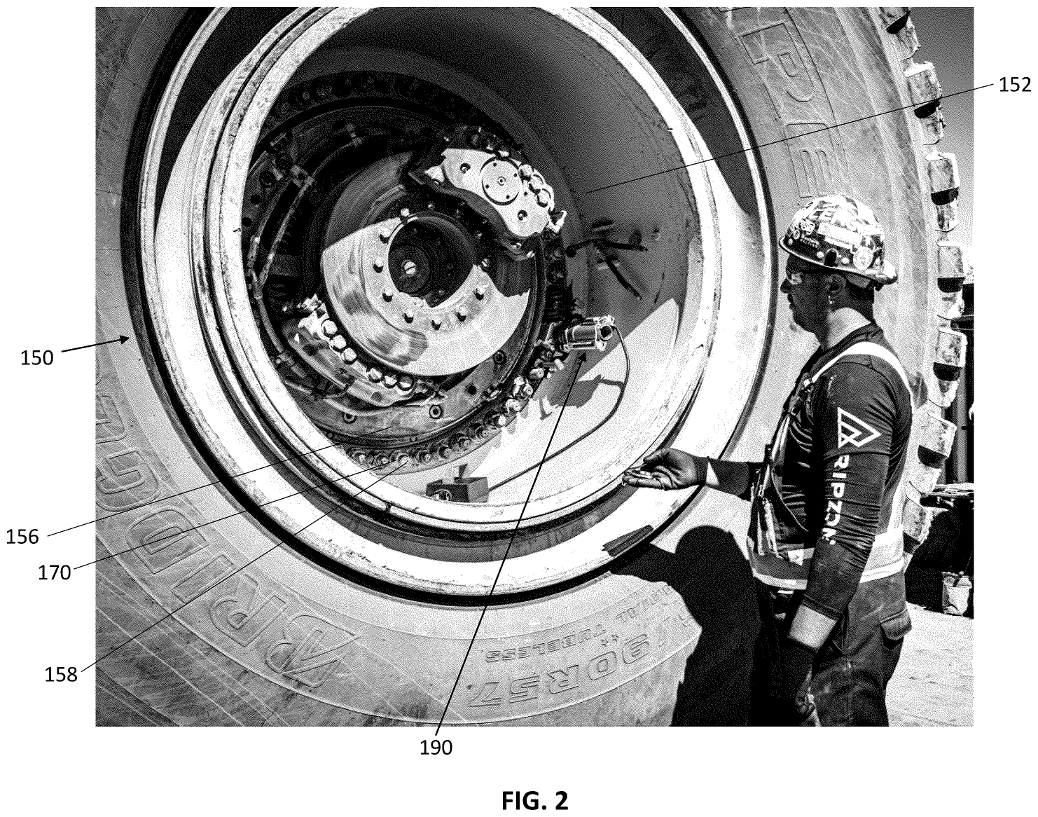

Referring to FIG. 2, another typical wheel mounting assembly is shown generally at 150 and includes a large OTR wheel 152 and a hub 156. The wheel mounting assembly 150 is similar to the wheel mounting assembly 100, with the notable exception that the wheel 152 is shown mounted onto the hub 156. The wheel mounting assembly 150 further includes a plurality of studs, such as stud 158, mounted to the hub 156. As shown in FIG. 2, the plurality of studs is engaged with a plurality of internally threaded lug nuts, such as lug nut 170, to secure the wheel 152 to the hub 156. A clamp device according to one embodiment is shown generally at 190 attached to the wheel 152 and gripping one of the plurality of studs.

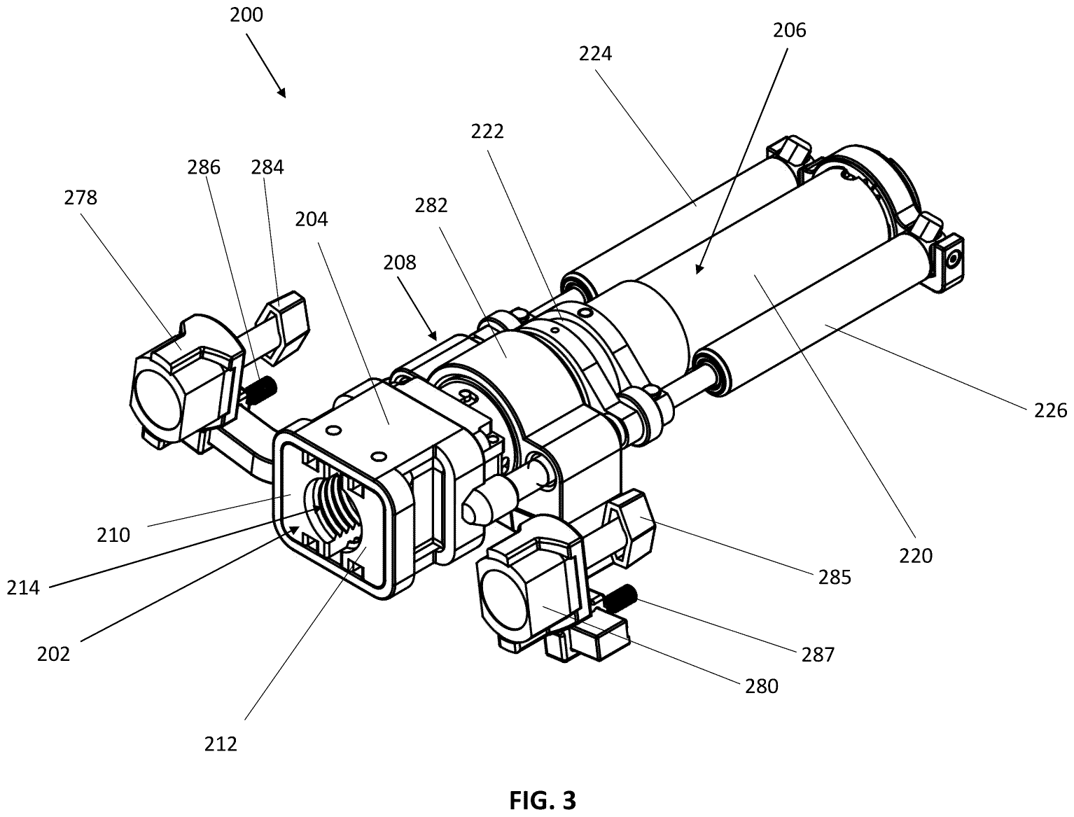

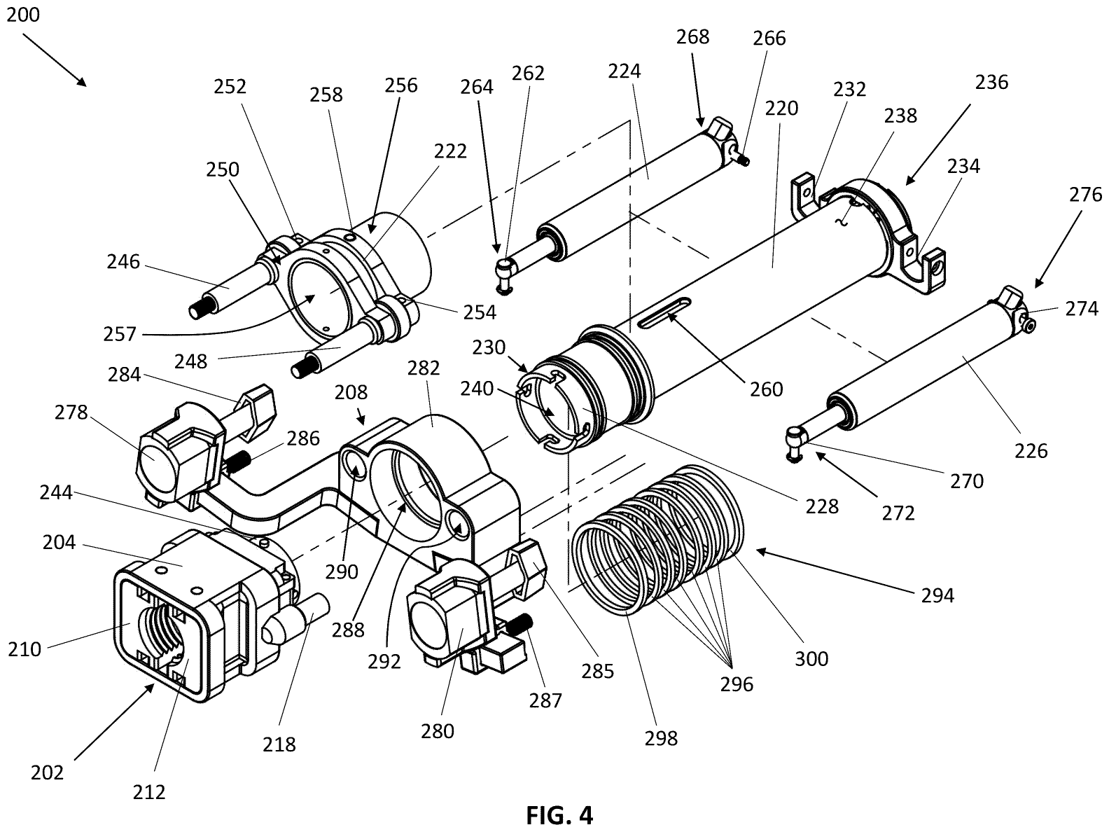

Referring now to FIGS. 3 and 4, a clamp device according to another embodiment is shown generally at 200 and includes a gripping mechanism 202, an actuating link 204, an actuator assembly 206, and an attachment mechanism 208. The gripping mechanism 202 is movable between an open position and a closed position. In the open position, the gripping mechanism is configured to accommodate a stud of a wheel mounting assembly, such as the stud 108 of the wheel mounting assembly 100, and may thus be located over the stud. In the closed position, the gripping mechanism 202 is configured to grip and hold the stud.

As shown in FIGS. 3 and 4, the gripping mechanism 202 includes a pair of pivotally attached jaws 210 and 212. When in the closed position, the pivotally attached jaws 210 and 212 define a housing 214 for enclosing the stud, such that the pivotally attached jaws 210 and 212 can grip the stud and hold it securely. In the embodiment shown, the housing 214 is generally cylindrical, with a radius corresponding to that of the stud. However, the gripping mechanism 202 is configured to be interchangeable with other gripping mechanisms. For example, the pivotally attached jaws 210 and 212 may be interchanged with other pairs of jaws which define other sizes and/or shapes of housings to accommodate different stud sizes, shapes, and pitch. In the embodiment shown, inner surfaces of the pivotally attached jaws 210 and 212 are threaded. However, in other embodiments, such surfaces may be non-threaded or relatively smooth. Each of the pivotally attached jaws 210 and 212 may be made from a metal such as, for example, a heat treated high-strength steel.

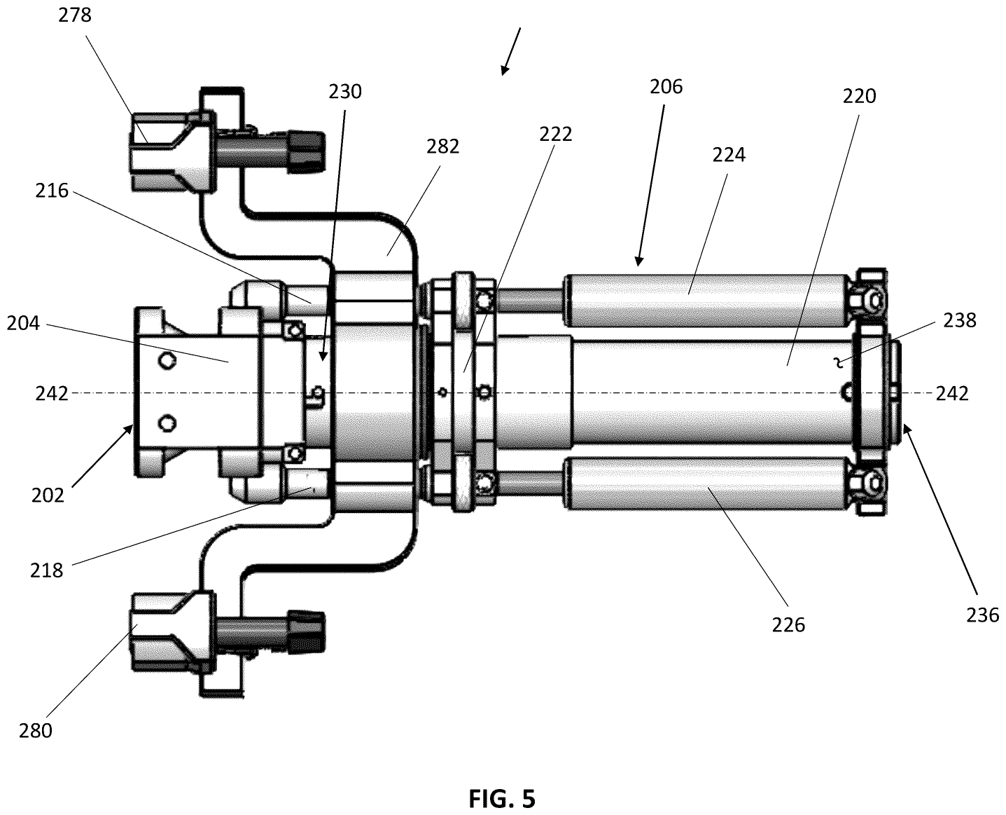

Referring now to FIGS. 3 to 5, the actuating link 204 engages with the gripping mechanism 202 and moves the gripping mechanism between the open position and the closed position. In the embodiment shown, the actuating link 204 is a collar that is in engagement with and configured to be movably disposed over the pair of pivotally attached jaws 210 and 212. The actuating link 204 also engages with the actuator assembly 206. To this end, the actuating link includes sockets 216 and 218 for engaging with the actuator assembly 206.

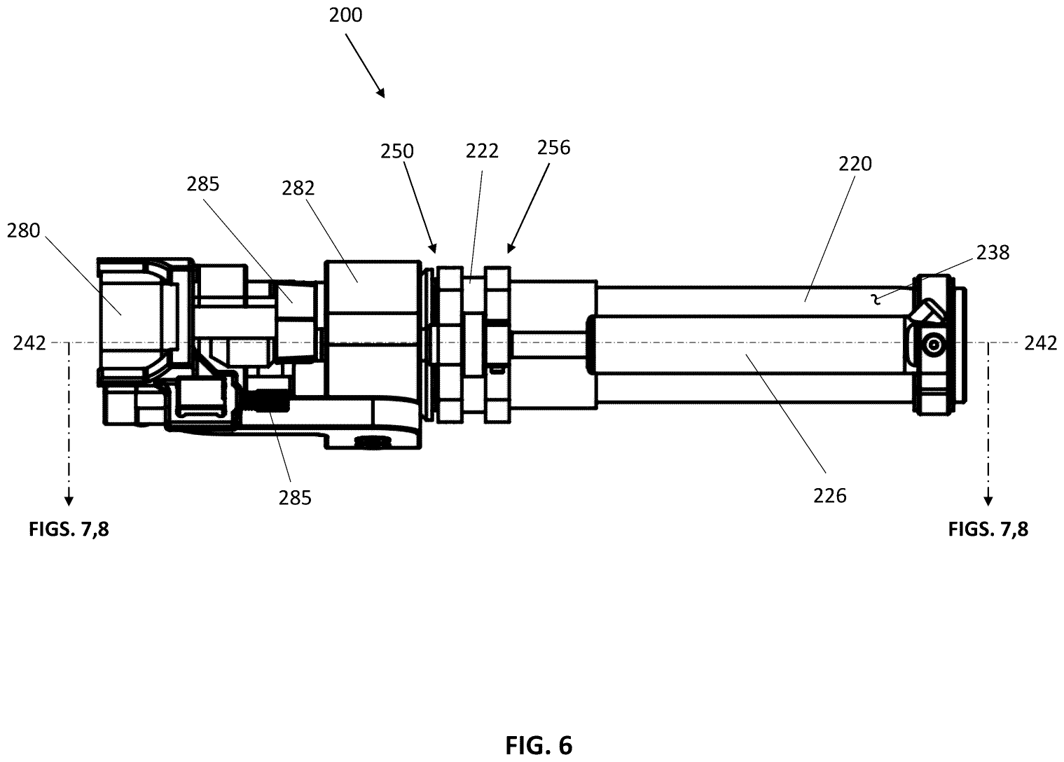

Referring now to FIGS. 3 to 8, the actuator assembly 206 includes a frame 220, a slider 222, a first actuator 224, and a second actuator 226. The frame 220 includes a bayonet mount receptor 228 at a proximal end 230 of the frame 220, and a pair of actuator brackets 232 and 234 at a distal end 236 of the frame 220. As used in this disclosure, the term “proximal” generally refers to a part of a structure of the clamp device 200 that is closer to the gripping mechanism 202, whereas the term “distal” generally refers to a part of a structure of the clamp device 200 that is further away from the gripping mechanism 202. From the proximal end 230 to the distal end 236, the frame 220 has an external surface 238 and defines an internal central cavity 240 and a sliding axis 242.

The bayonet mount receptor 228 of the frame 220 releasably connects with a bayonet mount connector 244 of the gripping mechanism 202. Through this connection, the frame 220 supports the gripping mechanism 202, while the releasability of this connection provides a mechanism for removing and/or interchanging the gripping mechanism 202.

The central cavity 240 of the frame 220 is open to the gripping mechanism 202 and is sized to accommodate at least a portion of a wheel stud. Therefore, when a stud is gripped by the gripping mechanism 202, any portion of the stud that projects beyond the housing 214 may extend into (and, if necessary, through) the central cavity 240. This configuration allows the clamp device 200 to securely grip long wheel studs, including wheel studs that are longer than the clamp device 200 itself.

The slider 222 includes a pair of slider arms 246 and 248 projecting from a proximal side 250 of the slider 222, and a pair of actuator brackets 252 and 254 at a distal side 256 of the slider 222. The slider arms 246 and 248 engage and connect with the sockets 216 and 218, respectively, of the actuating link 204. These connections, between the slider arm 246 and the socket 216 and between the slider arm 248 and the socket 218, provide a pair of contact points for engagement between the slider 222 and the actuating link 204, and thus between the actuating mechanism 206 and the actuating link 204. Accordingly, through the slider 222, the actuating mechanism 206 may control movement of the actuating link 204 and, in turn, the gripping mechanism 202. While the embodiment shown includes two contact points of engagement between the slider 222 and the actuating link 204, in other embodiments, the slider 222 may engage with the actuating link 204 at a single contact point, or at more than two contact points.

The slider 222 defines an internal cavity 257 sized and shaped to accommodate a section of the frame 220 for axial movement along the sliding axis 242. The frame 220 is positioned within the internal cavity 257 such that the slider 222 slidably engages the frame 220 at the external surface 238 and slides along the sliding axis 242. The slider 222 also includes an alignment post 258 which projects into the internal cavity 257 and engages an alignment slot 260 defined by the frame on the external surface 238. Engagement of the alignment post 258 with the alignment slot 260 prevents rotation of the slider 222 relative to the frame 220, while permitting the slider 222 to slide along the sliding axis 242. Engagement of the alignment post 258 with the alignment slot 260 may also limit a sliding range of the slider 222 along the sliding axis 242.

The first actuator 224 includes a slider mount 262 at a proximal end 264 of the first actuator 224, and a frame mount 266 at a distal end 268 of the first actuator 224. Similarly, the second actuator 226 includes a slider mount 270 at a proximal end 272 of the second actuator 226 and a frame mount 274 at a distal end 276 of the second actuator 226. The slider mounts 262 and 270 attach to the actuator brackets 252 and 254, respectively, of the slider 222, and the frame mounts 266 and 274 attach to the actuator brackets 232 and 234, respectively, of the frame 220. Therefore, each of the first and second actuators 224 and 226 is supported by the frame 220 at their respective distal ends 268 and 276, and each of the first and second actuators 224 and 226 engages the slider 222 at their respective proximal ends 264 and 272. Consequently, actuation of one or both of the first and second actuators 224 and 226 causes the slider 222 to move relative to the frame 220, sliding along the sliding axis 242.

In the embodiment shown, the first and second actuators 224 and 226 are electromagnetic actuators. However, in other embodiments, the first and second actuators 224 and 226 may be any electrical, mechanical, hydraulic, or pneumatic devices capable of moving or controlling something.

The first and second actuators 224 and 226 are generally configured to actuate substantially synchronously (i.e., at the same rate). However, in some cases, the first and second actuators 224 and 226 may actuate asynchronously or out of sync. Due to the slidable engagement between the slider 222 and the frame 220, the slider 222 is restricted in its motion to sliding along the sliding axis 242. Therefore, even if the first and second actuators 224 and 226 actuate asynchronously, the slider 222 will slide along the sliding axis 242 to control movement of the actuating link 204 and thus the gripping mechanism 202.

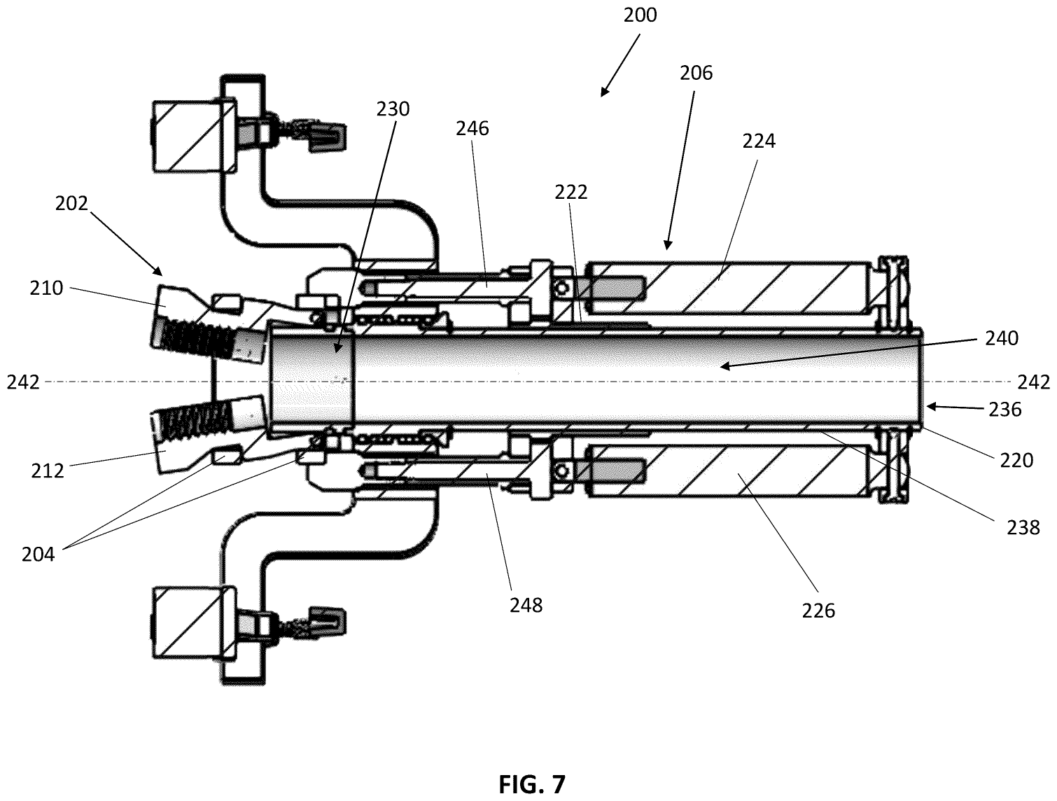

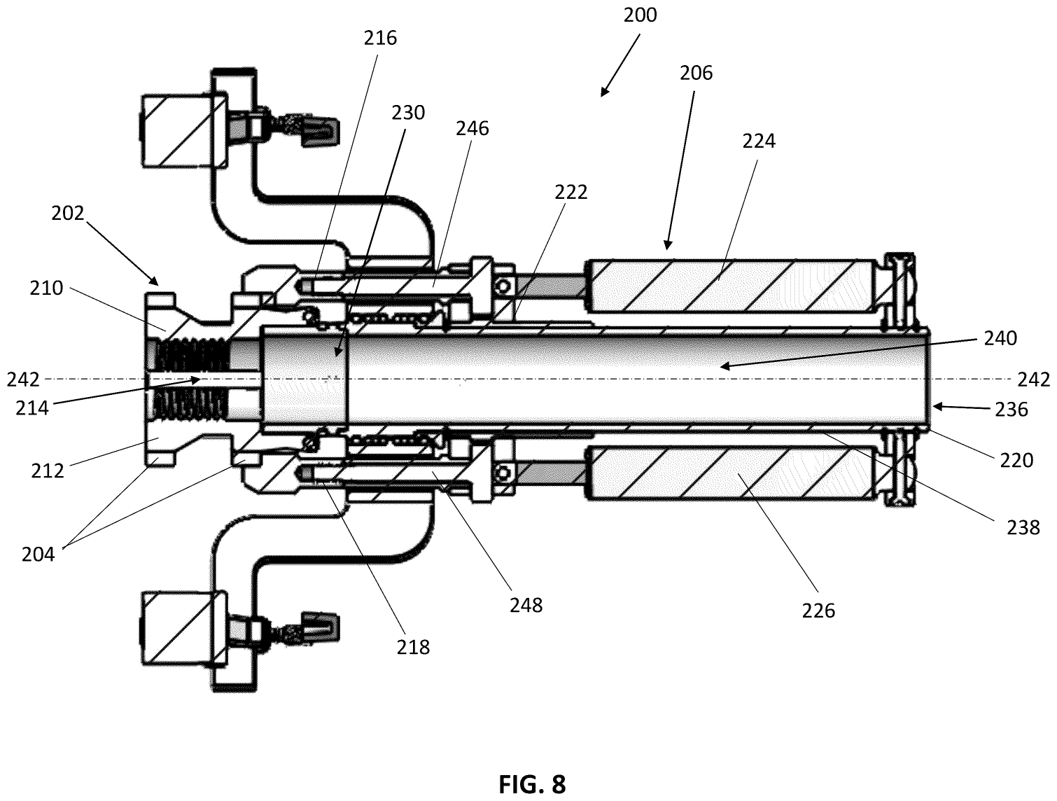

Referring to FIGS. 7 and 8, in operation, in response to operating commands inputted by a user, the actuator assembly 206 controls the actuating link 204 to move the gripping mechanism 202 between the open position, as depicted in FIG. 7, and the closed position, as depicted in FIG. 8. More specifically, the actuating link 204 is movable between an opening position depicted in FIG. 7 and a closing position depicted in FIG. 8. The actuating link 204 is configured to cause the gripping mechanism 202 to move to the open position when the actuating link 204 moves to the opening position, and to cause the gripping mechanism 202 to move to the closed position when the actuating link 204 moves to the closing position.

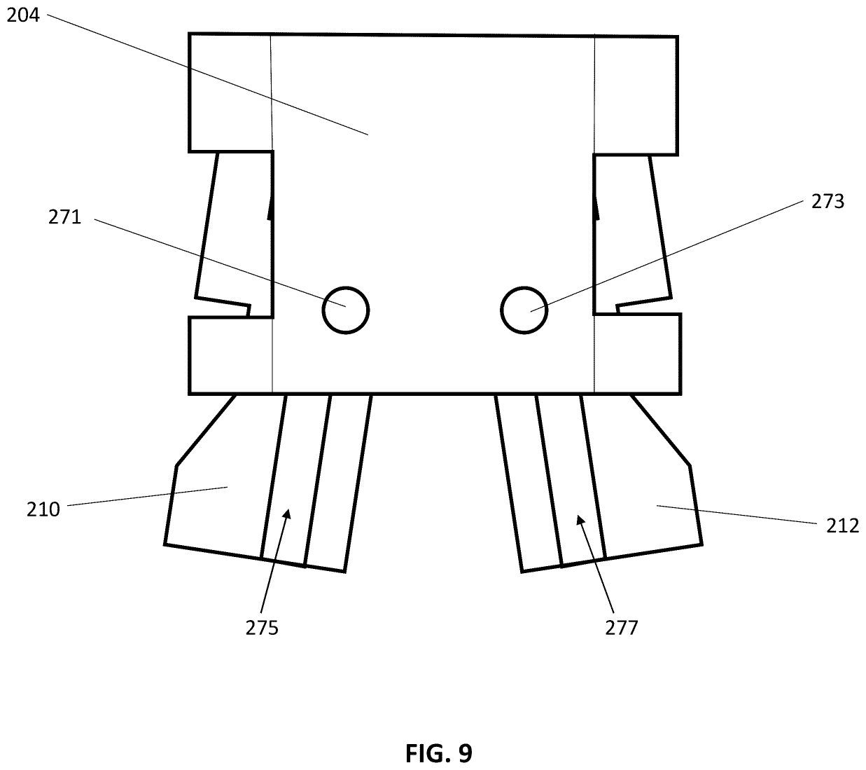

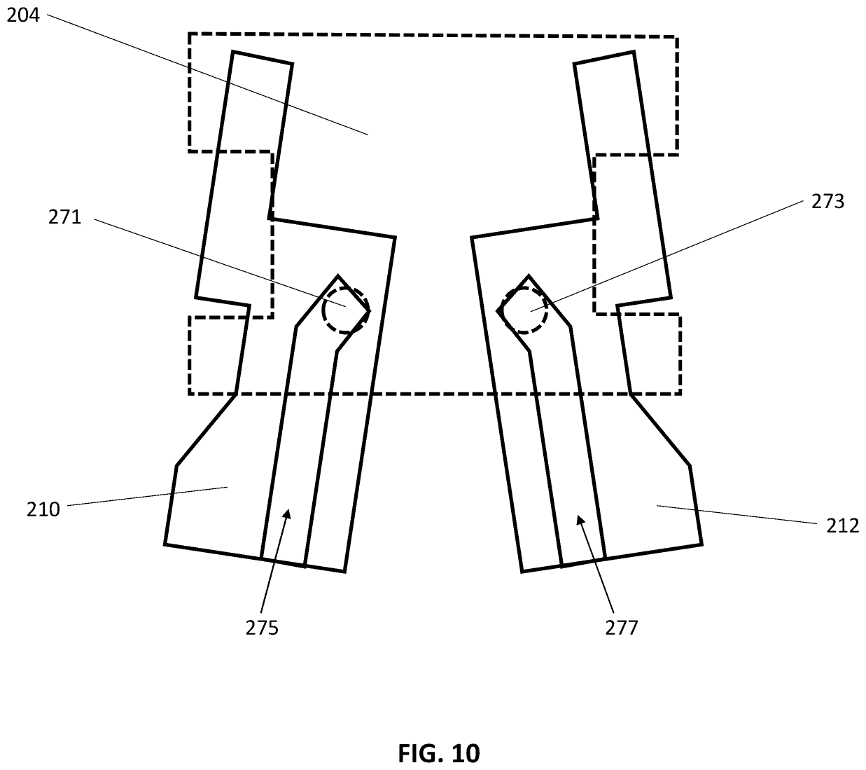

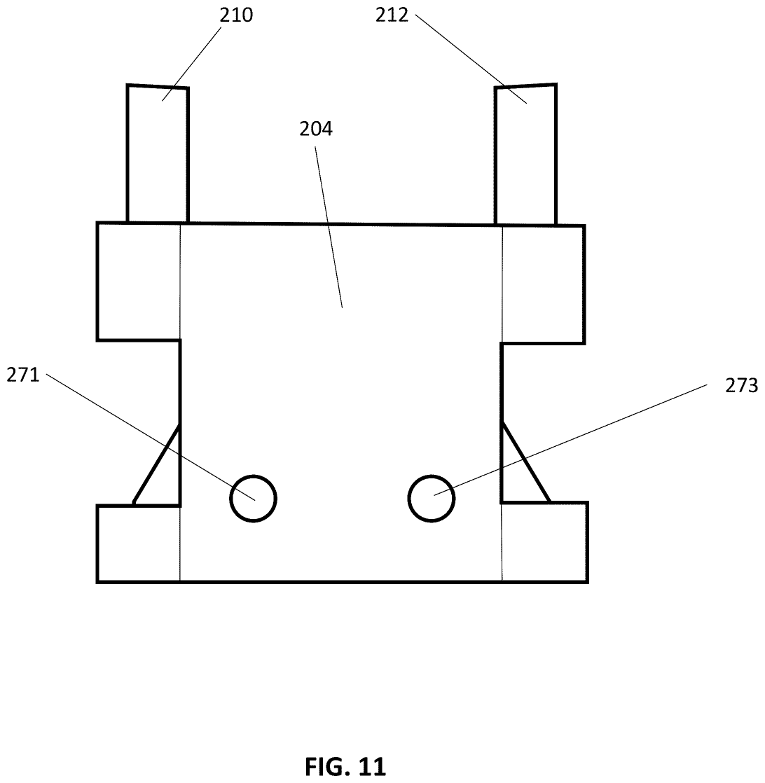

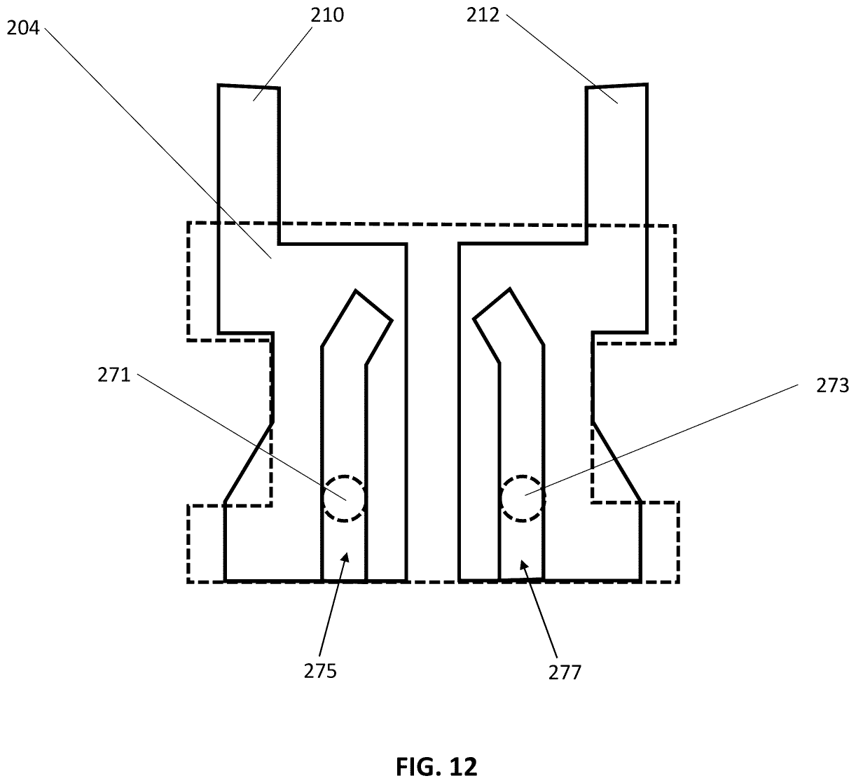

Referring to FIGS. 9 to 12, the actuating link 204 includes inwardly projecting pins 271 and 273. The pivotally attached jaw 210 of the gripping mechanism 202 defines a slot 275, and, similarly, the pivotally attached jaw 212 defines a slot 277. The pins 271 and 273 are configured to slidably engage the slots 275 and 277, respectively, such that when the actuating link 204 moves between the opening position (depicted in FIGS. 9 and 10) and the closing position (depicted in FIGS. 11 and 12), engagement between the pins 271 and 273 and the slots 275 and 277 precisely guides movement of the pivotally attached jaws 210 and 212 as the gripping mechanism 202 moves between the open position and the closed position. FIGS. 9 to 12 show a top view of the gripping mechanism 202 and the actuating link 204. Thus, the pins 271 and 273 are located on a top surface of the actuating link 204 and the slots 275 and 277 are located on top surfaces of the pivotally attached jaws 210 and 212, respectively. However, the actuating link 204 may further include a corresponding second pair of pins (not shown) on its bottom surface, and each of the pivotally attached jaws 210 and 212 may further define another corresponding slot (not shown) on its bottom surface. In the embodiment shown, the slots 275 and 277 are mostly straight with a turn at one end. In other embodiments, the pivotally attached jaws 210 and 212 may have differently shaped slots, or may not include slots at all.

Referring back to FIGS. 7 and 8, the first and second actuators 224 and 226 are operable to slide the slider 222 along the sliding axis 242 between a first slider position, depicted in FIG. 7, and a second slider position, depicted in FIG. 8, in response to the operating commands from the user. In the embodiment shown, the slider 222 slides to the first slider position when the first and second actuators 224 and 226 retract, and slides to the second slider position when the first and second actuators 224 and 226 extend. The slider 222 is configured to cause the actuating link 204 to move to the opening position when the slider 222 slides to the first slider position, and to cause the actuating link 204 to move to the closing position when the slider 222 slides to the second slider position.

Thus, as an operational example, the clamp device 200 could be positioned over a wheel stud with the gripping mechanism 202 in the open position, the actuating link 204 in the opening position, the slider 222 in the first slider position, and the first and second actuators 224 and 226 retracted, as depicted in FIG. 7. Upon receipt of a user command to close the gripping mechanism 202 and the grip the stud, the first and second actuators 224 and 226 would extend, causing the slider 222 to move to the second position, the actuating link 204 to move to the closing position, and the gripping mechanism 202 to move to the closed position, as depicted in FIG. 8, such that the pair of pivotally attached jaws 210 and 212 enclose and grip the stud.

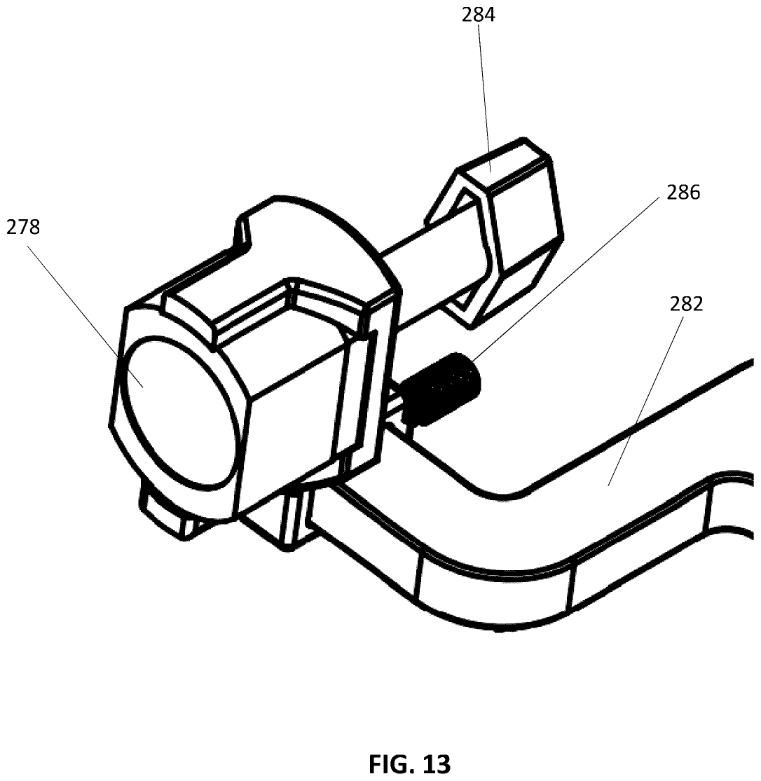

Referring now to FIGS. 3 to 8 and 13, the attachment mechanism 208 is generally operable to releasably attach the clamp device 200 to a wheel when using the clamp device 200 to grip a stud of the wheel mounting assembly. The attachment mechanism includes a first anchoring device 278, a second anchoring device 280, and a support structure 282. Each of the first and second anchoring devices 278 and 280 is operable to releasably attach to an attachment surface of the wheel. In the embodiment shown, the first and second anchoring devices 278 and 280 are configured to attach to an attachment surface that is substantially perpendicular to an axis of rotation of the wheel. For example, such an attachment surface could be a center disc of a wheel, such as the center disc 114 of the wheel 102 as best shown in FIG. 1. In the embodiment shown, each of the first and second anchoring devices 278 and 280 is a switchable magnetic device operable to selectively provide a strong external magnetic field for attachment to an external ferromagnetic material, such as the attachment surface. The first anchoring device 278 includes a switch 284 (see in particular FIG. 13), and the second anchoring device 280 includes a switch 285. The switches 284 and 285 are operable to control the magnetic fields, and thus attachment and release, of the first and second anchoring devices, respectively.

The support structure 282 supports the first and second anchoring devices 278 and 280 and positions the first and second anchoring devices 278 and 280 to attach to the attachment surface when the gripping mechanism 202 grips the stud. In the embodiment shown, the support structure 282 positions the first and second anchoring devices 278 and 280 on opposing sides of the gripping mechanism 202. The first and second anchoring devices 278 and 280 are movable along the support structure 282 such that the positions of the first and second anchoring devices 278 and 280 relative to the gripping mechanism 202 can be adjusted. Specifically, in the embodiment shown, the first anchoring device 278 includes a mounting screw clamp 286 (see in particular FIG. 13), and the second anchoring device 280 includes a mounting screw clamp 287. The mounting screw clamps 286 and 267 releasably fix the first and second anchoring devices 278 and 280, respectively, to the support structure 282. As such, the mounting screw clamps 286 and 267 are operable to release the first and second anchoring devices 278 and 280 from the support structure 282 so that the first and second anchoring devices 278 and 280 can be moved along the support structure 282 to new positions. Once the first and second anchoring devices 278 and 280 have been repositioned, the mounting screw clamps 286 and 267 are operable to fix the first and second anchoring devices 278 and 280 in place on the support structure 282.

The support structure 282 also defines a central opening 288 and a pair of slider openings 290 and 292. The central opening 288 is sized and shaped to accommodate the proximal end 230 of the frame 220, and the slider openings 290 and 292 are sized and shaped to accommodate the slider arms 246 and 248, respectively, of the slider 222. The frame 220 is positioned through the central opening 288 such that the central cavity 240 is aligned with the central opening 288. The slider arms 246 and 248 are positioned through the slider openings 290 and 292 and are configured to move through the slider openings 290 and 292 when the slider 222 slides along the sliding axis 242.

Referring back to FIG. 4, the clamp device 200 also includes a flexible linkage 294. When assembled together in the clamp device 200, the gripping mechanism 202, the actuating link 204, and the actuator assembly 206 may collectively be referred to as a “gripping assembly” of the clamp device 200. The flexible linkage 294 is generally disposed between this gripping assembly and the attachment mechanism 208. In the embodiment shown, the flexible linkage 294 is more specifically disposed between the frame 220 of the actuator assembly 206 and the support structure 282 of the attachment mechanism 208. The flexible linkage 294 functions to accommodate movement between the gripping assembly and the attachment mechanism 208, such that when the attachment mechanism 208 is attached to the attachment surface, the gripping mechanism 202 is operable to self-align onto the stud as the gripping mechanism 202 moves to the closed position. In some embodiments, the flexible linkage 294 may join the gripping assembly to the attachment mechanism 208. In the embodiment shown, the flexible linkage 294 includes a plurality of foam rings 296 arranged in a stack and a pair of O-rings 298 and 300 disposed at either end of the stack of foam rings 296.

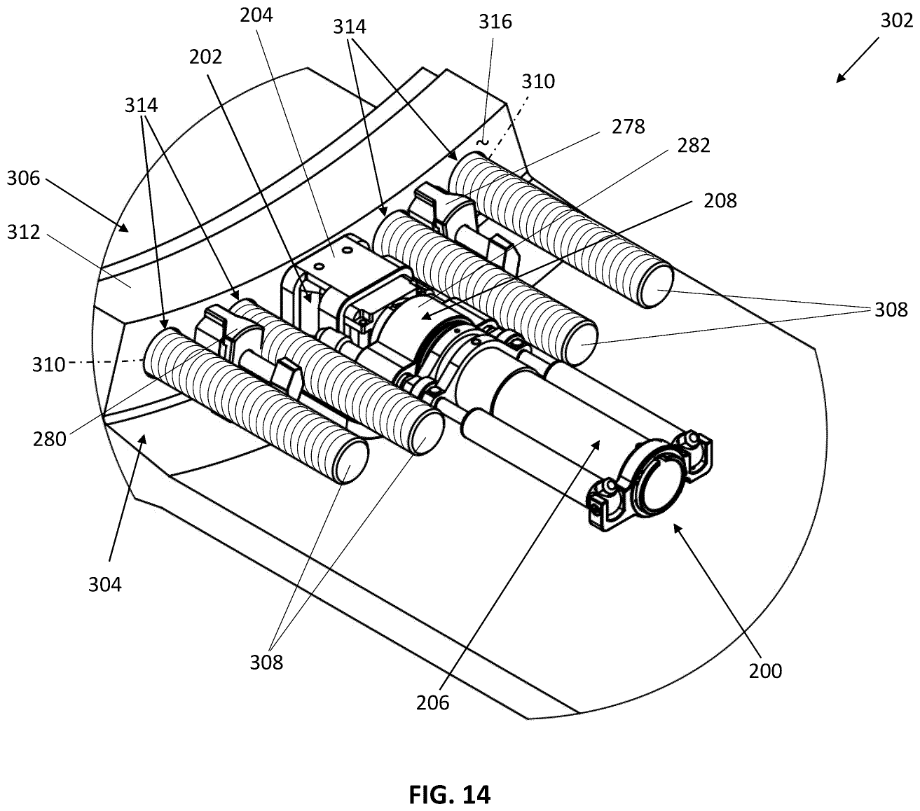

Referring now to FIG. 14, the clamp device 200 is shown being used with an exemplary wheel mounting assembly, shown generally at 302. The wheel mounting assembly 302 includes a wheel, partially shown generally at 304, and a hub, partially shown generally at 306. The hub 306 includes a plurality of studs 308 regularly spaced along a circumferential axis 310. The wheel 302 includes a center disc 312 which defines a plurality of openings or stud holes 314 regularly spaced along the circumferential axis 310 and sized and positioned to receive the plurality of studs 308 when the wheel 304 is mounted onto the hub 306. The center disc 312 also includes an attachment surface 316, which is substantially perpendicular to an axis of rotation of the wheel 304.

In operation, the clamp device 200 is used to temporarily hold the wheel 304 mounted onto the hub 306. For example, in some embodiments, as a first step, the anchoring devices 278 and 280 of the attachment mechanism 208 are used to attach the clamp device 200 to the attachment surface 316 of the wheel 304 such that the gripping mechanism 202 is positioned over and in line with a stud hole selected from the plurality of stud holes 314. With the gripping mechanism 202 thus positioned, the support structure 282 of the attachment mechanism 208 positions the first and second anchoring devices 278 and 280 such that the first and second anchoring devices 278 and 280 can attach to the attachment surface 316 between the stud holes 314 (and thus between the studs 308 when the studs 308 are positioned through the stud holes 314) along the circumferential axis 310. Next, when a stud is positioned through the selected stud hole, a first operating command is input to the actuator assembly 206 to cause the actuating link 204 to move to the closing position and thus move the gripping mechanism 202 to the closed position to grip the stud and hold the wheel 304 mounted onto the hub 306. A second operating command is then input to the actuator assembly 206 to cause the actuating link 204 to move to the opening position and thus move the gripping mechanism 202 to the open position to release the stud. Finally, the anchoring devices 278 and 280 are disengaged, allowing the attachment mechanism 208, and thus the clamp device 200, to be released from the wheel 304.

The operational steps as set out above may be used when installing or removing the wheel 302 from the hub 306. However, when removing the wheel 302 from the hub 306, an alternative set of operational steps may be used instead. In this alternative embodiment, as a first step, the clamp device 200 is positioned over and in line with a stud selected from the plurality of studs 308, with the first and second anchoring devices 278 and 280 positioned above the attachment surface 316 between the holes 314 along the circumferential axis 310. Next, a first operating command is input to the actuator assembly 206 to cause the actuating link 204 to move to the closing position and thus move the gripping mechanism 202 to the closed position to grip the stud and hold the wheel 304 mounted onto the hub 306. The first and second anchoring devices 278 and 280 are then used to attach the clamp device 200 to the attachment surface 316. When the wheel 302 is ready to be removed from the hub 306, a second operating command is input to the actuator assembly 206 to cause the actuating link 204 to move to the opening position and thus move the gripping mechanism 202 to the open position to release the stud. Finally, after the wheel 302 has been removed, the anchoring devices 278 and 280 are disengaged, allowing the attachment mechanism 208, and thus the clamp device 200, to be released from the wheel 304.

In some embodiments, when installing the wheel 302 onto the hub 306, a simulated stud (not shown) may be used to help align the clamp device 200 to the selected stud hole prior to attaching the clamp device 200 to the wheel 302. In such embodiments, before the wheel 302 is mounted onto the hub 306, the simulated stud is inserted into the selected stud hole, such that a portion of the simulated stud projects outward from the stud hole in a position generally similar to that occupied by a stud when the plurality of studs 308 are positioned through the plurality of stud holes 314. The clamp device 200 is then positioned over and in line with the simulated stud, with the first and second anchoring devices 278 and 280 positioned above the attachment surface 316 between the holes 314 along the circumferential axis 310. Next, a first operating command is input to the actuator assembly 206 to cause the actuating link 204 to move to the closing position and thus move the gripping mechanism 202 to the closed position to grip the simulated stud. The first and second anchoring devices 278 and 280 are then used to attach the clamp device 200 to the attachment surface 316. Once the clamp device 200 has been thus attached, a second operating command is input to the actuator assembly 206 to cause the actuating link 204 to move to the opening position and thus move the gripping mechanism 202 to the open position to release the simulated stud. The simulated stud is then removed from the stud hole, and the wheel 302 may be mounted onto the hub 306 and installed using the clamp device 200 as described above. In some embodiments, the simulated stud may be sized to be movable into and out of the housing 214 of the gripping mechanism 202 when the gripping mechanism 202 is in the closed position. The simulated stud may be made of, for example, a plastic. As noted above, the simulated stud helps ensure that the clamp device 200 is closely aligned with the selected stud hole prior to mounting the wheel 302 onto the hub 306. If the clamp device 200 is not thus aligned, then there is a risk that one or more studs of the plurality of studs 308 could hit the gripping mechanism 202 as the wheel 302 is mounted onto the hub 306 and cause the clamp device 200 to be dislodged from the attachment surface 316.

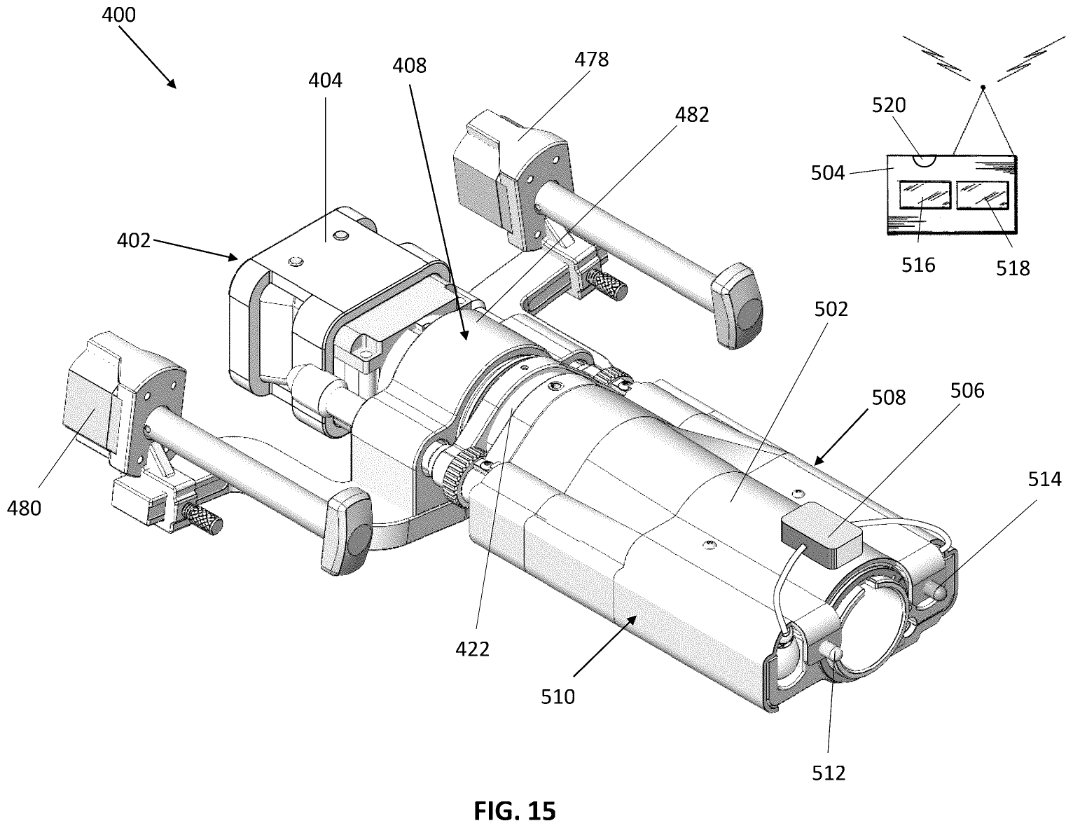

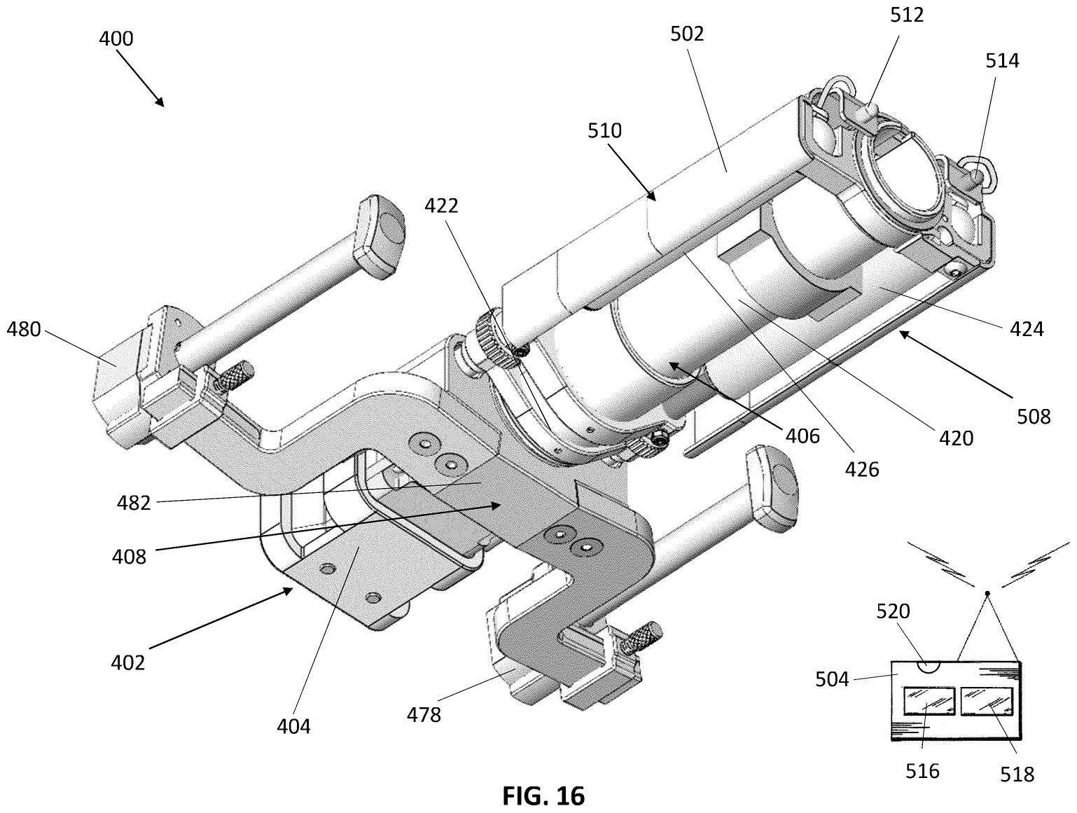

Referring to FIGS. 15 and 16, a clamp device according to another embodiment is shown generally at 400. The clamp device 400 is generally similar to the clamp device 200, and includes many of the same features. For example, the clamp device 400 includes a gripping mechanism 402, an actuating link 404, an actuator assembly 406 and an attachment mechanism 408, with the actuator assembly 406 including a frame 420, a slider 422, a first actuator 424 and a second actuator 426, and with the attachment mechanism 408 including a first anchoring device 478, a second anchoring device 480, and a support structure 482. However, the clamp device 400 additionally includes an outer housing 502, a transmitter 504, and a receiver 506.

The outer housing 502 surrounds one or more components of the clamp device 400, such as the gripping mechanism 402, the actuating link 404, and/or the actuator assembly 406. In the embodiment shown, the outer housing 502 surrounds the actuator assembly 406. The outer housing 502 may be a rigid shell configured to protect the underlying components of the clamp device 400 from impacts and/or moisture. For example, the outer housing 502 may be constructed from rigid and durable materials such as plastics, rubber, silicone, metals, alloys, treated nylons, cloth, canvas, leather, and combinations thereof. The outer housing 502 includes grasping points 508 and 510, a closed indicator light 512, and an open indicator light 514. The grasping points 508 and 510 are graspable by a user to carry and position the clamp device 400 during use. The closed indicator light 512 and the open indicator light 514 are used to indicate the position of the gripping mechanism 402. Specifically, the closed indicator light 512 illuminates when the gripping mechanism 402 is in the closed position, and the open indicator light 514 illuminates when the gripping mechanism 402 is in the open position.

The transmitter 504 receives operating commands from a user and transmits the operating commands to the receiver 506. In the embodiment shown, the transmitter 504 includes a closing button 516, an opening button 518, and a safety button 520. When the user presses the closing button 516, the transmitter 504 transmits a command to the receiver 506 to close the gripping mechanism 402. Similarly, when the user presses the opening button 518 in combination with the safety button 520, the transmitter 504 transmits a command to the receiver 506 to open the gripping mechanism 402. Requiring the safety button 520 to be pressed along with the opening button 518 to open the gripping mechanism 402 helps ensure that the gripping mechanism 402 does not accidentally open and release the stud.

Preferably, the transmitter 504 is a remote transmitter operable to remotely transmit the operating commands to the receiver 506. In the embodiment shown, the transmitter 504 is a remote transmitter that transmits the operating commands over a wireless connection. However, in other embodiments, the transmitter 504 may transmit the operating commands over a wired connection. The receiver 506 receives the operating commands and controls the first and second actuators 424 and 426 to move the slider 422, and thus the actuating link 404 and the gripping mechanism 402, in response to the operating commands.

Of course, the embodiments of FIGS. 2 to 16 are examples only, and alternative embodiments may vary. For example, alternative embodiments may include other types of gripping mechanisms or gripping mechanisms with more than two pivotally attached jaws. Alternative embodiments may also include a different sliding engagement between the slider 222 and the frame 220, such as a slider that slides inside a frame rather than along an external surface. Yet other alternative embodiments may not include a slider or frame at all, and may have the actuators directly engage the actuating link. Still other embodiments may include different numbers of actuators, such as a single actuator or more than two actuators.

Although specific embodiments have been described and illustrated, such embodiments should be considered illustrative only and not as limiting the invention as construed according to the accompanying claims.

1. A clamp device for gripping a stud of a wheel mounting assembly for mounting a wheel, the clamp device comprising:
a gripping mechanism movable between an open position to locate the gripping mechanism over the stud and a closed position to grip and hold the stud;
an actuating link for moving the gripping mechanism between the open position and the closed position;
an actuator assembly comprising:
a frame defining a sliding axis;
a slider for controlling the actuating link, the slider slidably engaging the frame and slidable along the sliding axis; and
a first actuator and a second actuator supported by the frame, the first and second actuators moving the slider in response to operating commands inputted by a user; and
an attachment mechanism operable to releasably attach the clamp device to the wheel.

2. The clamp device of claim 1, wherein:
the actuating link is movable between an opening position and a closing position;
the gripping mechanism is configured to move to the open position when the actuating link moves to the opening position; and
the gripping mechanism is configured to move to the closed position when the actuating link moves to the closing position.

3. (canceled)

4. (canceled)

5. The clamp device of claim 2, wherein:
the first and second actuators are operable to slide the slider along the sliding axis between a first slider position and a second slider position in response to the operating commands;
the actuating link is configured to move to the opening position when the slider slides to the first slider position; and
the actuating link is configured to move to the closing position when the slider slides to the second slider position.

6. (canceled)

7. (canceled)

8. The clamp device of claim 5, wherein:
the slider is configured to slide to the first slider position when the first and second actuators retract; and
the slider is configured to slide to the second slider position when the first and second actuators extend.

9-12. (canceled)

13. The clamp device of claim 1, wherein:
the slider slidably engages an external surface of the frame; and
the frame defines a central cavity configured to accommodate at least a portion of the stud when the gripping mechanism grips the stud.

14. (canceled)

15. (canceled)

16. The clamp device of claim 13, wherein:
the frame comprises an alignment slot;
the slider comprises an alignment post engaging the alignment slot; and
engagement of the alignment post with the alignment slot prevents rotation of the slider relative to the frame.

17. The clamp device of claim 16, wherein engagement of the alignment post with the alignment slot restricts a sliding range of the slider.

18. (canceled)

19. (canceled)

20. The clamp device of claim 1, wherein the first and second actuators are electromagnetic actuators.

21. (canceled)

22. A clamp device for gripping a stud of a wheel mounting assembly for mounting a wheel, the clamp device comprising:
a gripping mechanism movable between an open position to locate the gripping mechanism over the stud and a closed position to grip and hold the stud;
an actuating link for moving the gripping mechanism between the open position and the closed position;
an actuator for controlling the actuating link in response to operating commands inputted by a user; and
an attachment mechanism operable to releasably attach the clamp device to an attachment surface of the wheel, the attachment surface substantially perpendicular to an axis of rotation of the wheel.

23-26. (canceled)

27. The clamp device of claim 22, wherein:
the attachment mechanism comprises a first anchoring device and a second anchoring device, each of the first and second anchoring devices operable to releasably attach to the attachment surface;
the attachment mechanism further comprises a support structure supporting the first and second anchoring devices; and
the first and second anchoring devices are movable along the support structure.

28. (canceled)

29. A clamp device for gripping a stud of a wheel mounting assembly for mounting a wheel, the clamp device comprising:
a gripping assembly comprising:
a gripping mechanism movable between an open position to locate the gripping mechanism over the stud and a closed position to grip and hold the stud;
an actuating link for moving the gripping mechanism between the open position and the closed position; and
an actuator for controlling the actuating link in response to operating commands inputted by a user;
an attachment mechanism operable to releasably attach the clamp device to the wheel; and
a flexible linkage disposed between the gripping assembly and the attachment mechanism, the flexible linkage configured to accommodate movement between the gripping assembly and the attachment mechanism.

30. The clamp device of claim 29, wherein the flexible linkage is configured to accommodate movement between the gripping assembly and the attachment mechanism such that the gripping mechanism is operable to self-align onto the stud as it moves to the closed position.

31. The clamp device of claim 29, wherein the flexible linkage joins the gripping assembly to the attachment mechanism.

32. The clamp device of claim 29, wherein the flexible linkage comprises at least one O-ring.

33. The clamp device of claim 29, wherein the flexible linkage comprises at least one foam ring.

34. The clamp device of claim 29, wherein the flexible linkage comprises:
a plurality of foam rings arranged in a stack, the stack having a first end and a second end opposite the first end;
a first O-ring disposed at the first end; and
a second O-ring disposed at the second end.

35. A clamp device for gripping a stud of a wheel mounting assembly for mounting a wheel, the clamp device comprising:
a gripping mechanism movable between an open position to locate the gripping mechanism over the stud and a closed position to grip and hold the stud;
an actuating link for moving the gripping mechanism between the open position and the closed position;
an actuator for controlling the actuating in response to operating commands inputted by a user;
an attachment mechanism operable to releasably attach the clamp device to the wheel; and
an outer housing surrounding at least one of the gripping mechanism, the actuating link, and the actuator, the outer housing comprising a grasping point graspable by the user to position the clamp device.

36-45. (canceled)

46. The clamp device of claim 1, wherein the gripping mechanism is interchangeable with another gripping mechanism.

47. (canceled)

48. (canceled)

49. The clamp device of claim 1, wherein:
the gripping mechanism comprises a pair of pivotally attached jaws;
the actuating link comprises a collar configured to be movably disposed over the pair of pivotally attached jaws;
at least one of the pair of pivotally attached jaws defines a slot;
the collar comprises an inwardly projecting pin configured to slidably engage the slot; and
engagement between the pin and the slot precisely guides movement of the at least one of the pair of pivotally attached jaws as the gripping mechanism moves between the open position and the closed position.

50-52. (canceled)

53. A method of temporarily holding a wheel mounted onto a hub of a wheel mounting assembly, the hub having a plurality of studs onto which the wheel is mountable and the wheel having a plurality of stud holes configured to receive the plurality of studs, the method comprising:
attaching the clamp device of claim 1 by the attachment mechanism to the wheel over and in line with a stud hole selected from the plurality of stud holes;
inputting a first operating command to cause the actuating link to move the gripping mechanism to the closed position to hold the wheel mounted onto the hub;
inputting a second operating command to cause the actuating link to move the gripping mechanism to the open position; and
releasing the attachment mechanism from the wheel.

54. A method of temporarily holding a wheel mounted onto a hub of a wheel mounting assembly, the hub having a plurality of studs onto which the wheel is mounted, the method comprising:
positioning the clamp device of claim 1 over and in line with a stud selected from the plurality of studs;
inputting a first operating command to cause the actuating link to move the gripping mechanism to the closed position to hold the wheel mounted onto the hub;
attaching the clamp device by the attachment mechanism to the wheel;
inputting a second operating command to cause the actuating link to move the gripping mechanism to the open position; and
releasing the attachment mechanism from the wheel.
